(19) United States
(12) Patent Application Publication
(10) Pub. No.: US 2022/0318897 A1
(43) Pub. Date: Oct. 6, 2022

(54) Supplier Finance Syndications

(71) Applicant: Wells Fargo Bank, N.A., San Francisco, CA (US)

(72) Inventor: Armand J. Brunelle, III, Attleboro, MA (US)

(21) Appl. No.: 14/579,133

(22) Filed: Dec. 22, 2014

(51) Int. Cl. G06Q 40/02

(52) U.S. Cl. CPC G06Q 40/02

(57) ABSTRACT

An electronic computing device comprises a processing unit and system memory. The system memory includes instructions which, when executed by the processing unit, cause the electronic computing device to automatically determine a dollar amount of invoices to sell to one or more syndication participants. Each syndication participant is a financial institution with a capacity to finance a plurality of the invoices. A ranking order for one or more of the syndication participants is determined. A syndication participant with a high ranking order is selected. One or more invoices are selected for the syndication participant. A determination is made as to whether a dollar value for the one or more invoices is equal or greater than the dollar amount. When the dollar value for the one or more invoices is equal or greater than the dollar amount, the selected invoices are designated for syndication to the syndication participant.

### BACKGROUND

Suppliers of business products may sell their products to a plurality of buyers, typically other businesses. Similarly, businesses may buy products from a plurality of suppliers. Businesses that buy products from suppliers may have different payment terms. Suppliers may expect payment within a short period of time, for example 30 days from a sale, but some large businesses have the buying power to stretch payments out to a longer time, for example 90 days.

Financial institutions such as banks sometimes act as intermediaries between suppliers and buyers. The financial institutions can offer faster payment to suppliers than some suppliers can expect from buyers. The financial institutions can offer the faster payment by paying less on the invoice to the supplier. The difference between a face value of an invoice and what a supplier receives for early payment of the invoice is typically known as a discount cost for the supplier. The discount cost constitutes income for the financial institution for providing the early payment.

When financial institutions provide early payment to suppliers, the financial institution may need to finance the payment to the supplier because the buyer doesn't pay the financial institution until the actual due date of the invoice. When financial institutions provide an early payment service to a plurality of suppliers for a plurality of invoices, financial institutions often syndicate all or part of their invoices to obtain enough funds to provide the early payment to suppliers.

### SUMMARY

Embodiments of the disclosure are directed to an electronic computing device. The electronic computing device comprises a processing unit and system memory. The system memory includes instructions which, when executed by the processing unit, cause the electronic computing device to: automatically determine a first dollar amount of invoices to sell to one or more syndication participants, each syndication participant being a financial institution with a capacity to finance a plurality of the invoices; determine a ranking order for one or more of the syndication participants; select a first syndication participant with a high ranking order; select one or more first invoices for the first syndication participant; determine whether a first dollar value for the one or more first invoices is equal or greater than the first dollar amount; and when the first dollar value for the one or more first invoices is equal or greater than the first dollar amount, designate the selected first invoices for syndication to the first syndication participant.

In another aspect, a method an electronic computing device comprises: a processing unit and system memory. The system memory includes instructions which, when executed by the processing unit, cause the electronic computing device to: automatically determine a first dollar amount of invoices to sell to one or more syndication participants, each syndication participant being a financial institution with a capacity to finance a plurality of the invoices; determine a ranking order for one or more of the syndication participants; select a first syndication participant with a high ranking order; select one or more first invoices for the first syndication participant; determine whether a first dollar value for the one or more first invoices is equal or greater than the first dollar amount; when the first dollar value for the one or more first invoices is equal or greater than the first dollar amount, designate the selected first invoices for syndication to the first syndication participant; and when the first dollar value is not equal or greater than the first dollar amount: select one or more additional syndication participants; select one or more second invoices for the one or more additional syndication participants until a sum of the first dollar value and a second dollar value is equal to or greater than the first dollar amount, wherein the second dollar value comprises a dollar amount of the one or more second invoices; and designate the selected first and second invoices for syndication to the selected syndication participants.

In yet another aspect, a computer-readable data storage memory comprises instructions that, when executed by a processing unit of an electronic computing device, cause the processing unit to: automatically determine a first dollar amount of invoices to sell to one or more syndication participants, each syndication participant being a financial institution with a capacity to finance a plurality of the invoices; determine a ranking order for one or more of the syndication participants; select a first syndication participant with a high ranking order; select one or more first invoices for the first syndication participant; determine whether a first dollar value for the one or more first invoices is equal or greater than the first dollar amount; when the first dollar value for the one or more first invoices is equal or greater than the first dollar amount, designate the selected first invoices for syndication to the first syndication participant; and when the first dollar value is not equal or greater than the first dollar amount: select one or more additional syndication participants; select one or more second invoices for the one or more additional syndication participants until a sum of the first dollar value and a second dollar value is equal to or greater than the first dollar amount, wherein the second dollar value comprises a dollar amount of the one or more second invoices; and designate the selected first and second invoices for syndication to the selected syndication participants.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports supplier finance syndication.

FIG. 2 shows example modules of the invoice syndication processing engine of FIG. 1.

FIG. 3 shows an excerpt from an example spreadsheet that illustrates a determination of funding needed for invoice syndication.

FIG. 4 shows a table that lists criteria for determining syndication participants.

FIG. 5 shows a flowchart for an example method implemented on the invoice syndication processing engine of FIG. 1 for selecting invoices for syndication.

FIG. 6 shows example physical components of the financial institution server computer of FIG. 1.

### DETAILED DESCRIPTION

The present disclosure is directed to systems and methods for automating a process of supply chain finance invoice syndication for financial institutions. Supply chain finance involves the financial institutions acting as intermediaries between suppliers and buyers in order to expedite payment to suppliers and to permit buyers to stretch out payment on purchase invoices from the suppliers. Syndication of invoices involves a first financial institution selling to one or more other financial institutions all or part of invoices that the first financial institution receives from the buyers. In this way, the first financial institution can obtain sufficient funds to provide early payment to suppliers. In this disclosure, financial institutions that accept invoices for syndication are referred to as syndication participants. Also in this disclosure, the financial institution that provides the invoices to the syndication participants is referred to as a bank. However, other financial institutions besides banks can provide the invoices for syndication to the syndication participants.

A bank may receive many invoices from a plurality of buyers and may need to offer a large number of invoices for syndication. Using the systems and methods, the bank can automate a selection of invoices to offer for syndication. The automation is based on predetermined criteria, as explained in more detail later herein. The automation can result in an optimal selection of invoices that can be sold for syndication to one or more syndication participants. The selection of invoices can be such that a required dollar amount is received for the bank and that costs, for example interest costs, relating to the syndication are minimized.

The systems and methods also implement a cash settlement engine that returns cash for an invoice to the syndication participants as the cash is received from a buyer. The bank can receive cash daily from buyers when invoices are due. New invoices can also be received on a daily basis from buyers.

In addition, the systems and method implement a procedure to determine whether an invoice hold capacity has been exceeded for each syndication participant. When a hold capacity percentage is within a predetermined percentage of a maximum, an alert can sent to personnel at the bank.

In the examples described herein, the syndication is accomplished using computing devices that have been programmed to perform special, complex functions. These specially-programmed devices function to manipulate and provide data to the users in an improved form factor and with greater efficiency.

For example, as described in more detail below, the processes performed by the computing devices allows the user to more effectively and efficiently select invoices for syndication. Such processes can be accomplished using logic and interfaces that are more intuitive and robust for the user.

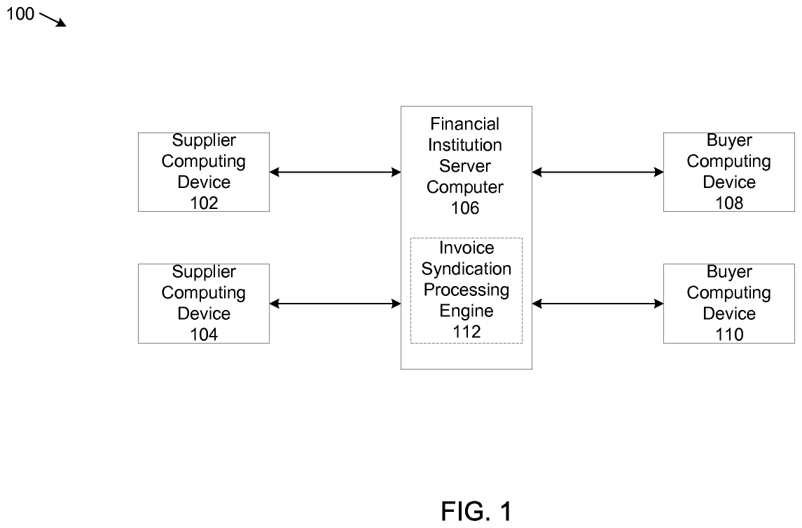

FIG. 1 shows an example system 100 that supports supplier finance syndication. The example system 100 includes supplier computing devices and 104, a financial institution server computer 106 and buyer computing devices 108 and 110. The financial institution server computer 106 includes an invoice syndication processing engine 112. More or fewer supplier computing devices and buyer computing devices may be used.

The supplier computing devices 102, 104 are computing devices for suppliers of products and/or services. The supplier computing devices 102, 104 may be client computers, laptop computers, desktop computers, mobile devices such as smartphones or any similar electronic computing devices. In system 100, supplier computing device 102 represents a computing device for one supplier and supplier computing device 104 represents a computing device for a second supplier. However each of the first supplier and second supplier typically has more than one computing device. In addition, system 100 can include computing devices (not shown) from additional suppliers.

The buyer computing devices 108, 110 are computing devices for buyers of the business products sold by suppliers, including the first supplier, the second supplier and any additional supplier in system 100. The buyers are businesses that use the products sold by the suppliers. The buyer computing devices may be server computers, client computers, laptop computers, desktop computers, mobile devices or any similar electronic computing devices. In system 100, buyer computing device 108 represents a computing device for one business, typically a retailer, and buyer computing device 110 represents a computing device for a second business. However each of the first buyer and second buyer typically has more than one computing device. In addition, system 100 can include computing devices (not shown) from additional buyers.

The financial institution server computer 106 is a server computer at a financial institution, herein referred to as a bank. The bank is one that provides a third party supplier finance service for the suppliers and the buyers. The bank can make money by providing an early payment service to suppliers. The suppliers generally pay a fee, sometimes known as a discount, to the bank for the early payment service. The discount fee constitutes income for the bank.

The example invoice syndication processing engine 112 includes software modules that implement automatic selection of invoices for syndication, cash settlement of invoices and capacity alert detection.

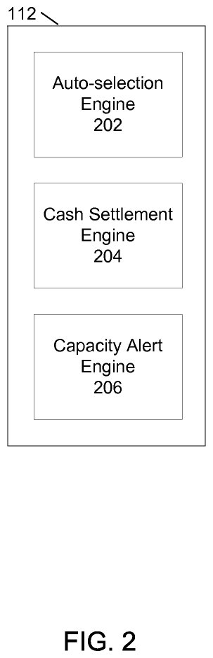

FIG. 2 shows example modules 200 for the invoice syndication processing engine 112. The invoice syndication processing engine includes an auto-selection engine 202, a cash settlement engine 204 and a capacity alert engine 206.

The example auto-selection engine 202 automates a process for selecting invoices for syndication. In a first step, the auto-selection engine 202 determines a total dollar amount of invoices to syndicate for each buyer. The total dollar amount is determined using criteria including a buyer credit limit, a dollar amount of non-syndicated invoices from the buyer, scheduled cash payments expected from the buyer, scheduled payments from the bank to syndication participants and projected new invoices expected to be received from the buyer. For some banks, the criteria are generated daily and the process for forecasting the total dollar amount is performed daily. A more detailed explanation of how the total dollar amount is determined in provided later herein.

Based on these criteria, the auto-selection engine 202 may determine that a total dollar amount of invoices that can be sold for syndication for a buyer on a given day is either a positive or a negative number. When the total dollar amount is a negative number, no invoices are sold for syndication for the buyer on the given day. When the total dollar amount is a positive number, at least the total dollar amount corresponding to the positive number is the amount of invoices to be sold on the given day. Partial invoices are not offered for syndication. Therefore, the auto-selection engine 202 selects a set of invoices having a face value which provides at least the required total dollar amount.

Once the required dollar amount is determined, invoices from the buyer are selected in order to generate the required dollar amount. One criterion that is generally used to determine which invoices to select for syndication is days sales outstanding (DSO). The DSO represents a number of days from a settlement date for an invoice and the invoice due date. The settlement date corresponds to when the invoice is sold to a syndication participant. The invoice due date is a date on which payment is received at the bank for the invoice from the buyer. In some implementations, an initial set of invoices is reduced in size by eliminating invoices for which the DSO is below a predetermined threshold, for example 20 days. The threshold sometimes corresponds to a minimum number of days before an invoice is due before a supplier can receive an early payment. Based on the DSO, the auto-selection engine 202 can select a set of invoices for the required dollar amount and exclude invoices for which the DSO is below the predetermined threshold.

After the auto-selection engine 202 selects a set of invoices to provide the required dollar amount, the auto-selection engine 202 determines one or more syndication participants to which to receive the selected invoices. The syndication participants can finance the selected invoices by paying the bank the dollar amount of the selected invoices. The syndication participants make money by charging interest or other fees to the bank when an invoice is accepted for syndication. A process used by the auto-selection engine 202 to select syndication participants is described later herein.

In some implementations, the auto-selection engine 202 may facilitate a bidding process among syndication participants for invoices. In these implementations, when the auto-selection engine 202 selects the set of invoices to provide the required dollar amount, information regarding the set of invoices can be published via a portal of the financial institution server computer 106. Prospective syndication participants can view the available invoices and indicate a price (discount) that they would charge the bank for accepting an invoice. Because the prospective syndication participants know that the bank would accept a syndication participant with the lowest price for an invoice (corresponding to the lowest cost to the bank), a syndication participant can adjust the price that it would charge the bank to a price that the syndication participant believes would win the bid. In addition, to adjusting a price that the syndication participant would charge the bank, the syndication participant can also use the portal to adjust a dollar amount of invoices that the syndication participant is willing to buy from the bank.

The example cash settlement engine 204 provides cash payments to syndicated participants when cash payment is received from the buyer for one or more invoices. The cash payment is usually received from the buyer for the one or more invoices at or near the due date for the one or more invoices. When the cash payment is received from the buyer, the cash settlement engine 204 makes a determination as to which syndication participant is due payment for the one or more invoices. The cash settlement engine 204 then initiates a payment process for the syndication participant. Payment is for the full amount of the one or more invoices.

The example capacity alert engine 206 provides an email alert to bank personnel when a limit utilization for a syndication participant reaches a predetermined percentage. The invoice syndication processing engine 112 can include a dollar limit of invoices that can be syndicated to syndication participants. In some implementations, there can be a separate dollar limit of invoices for syndication participants per buyer. When the dollar limit reaches the percentage, a syndication participant may be prevented from accepting any more invoices for a buyer. In some implementations, a temporary additional credit limit may be provided for the syndication participant to handle one or more current invoices. However, additional invoices may be blocked until the dollar amount for any outstanding invoices for the syndication participant falls below the predetermined percentage.

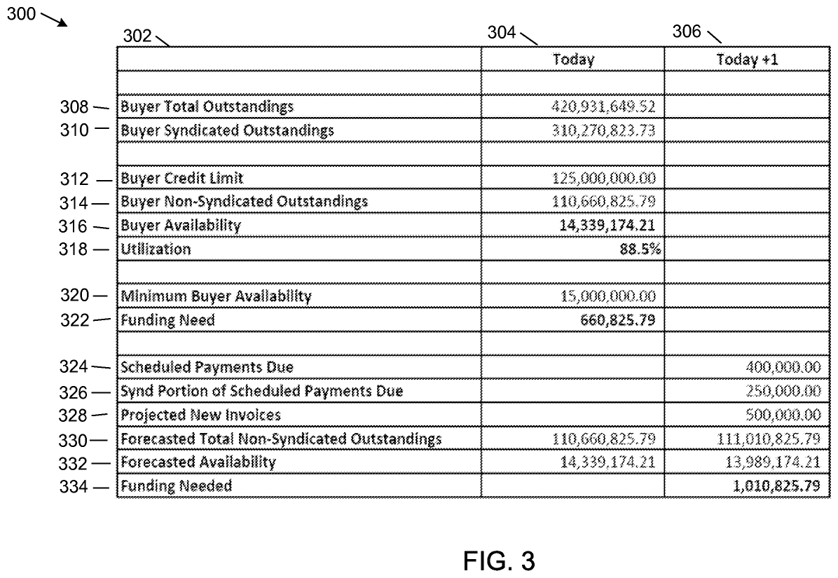

FIG. 3 shows an excerpt from an example spreadsheet 300 that shows how a dollar amount of invoices to syndicate from a buyer can be determined. The spreadsheet 300 includes a column 302 for certain funding categories and columns 304 and 306 showing example values of those funding categories for today (column 304—today) and a next day (column 306—today+1).

The following discussion relates to funding needs for today and refers to values in column 304. For today, a total dollar value of invoices outstanding from a buyer (buyer total outstandings 308) is $420,931,649.52. A dollar value of invoices for that buyer that is syndicated from this total (buyer syndicated outstandings 310) is $310,270,823.73. Subtracting $310,270,823.73 from $420,931.52, one arrives at a total dollar value for invoices that are non-syndicated for the buyer (buyer non-syndicated outstandings 314) of $110,660,825.79.

As shown in FIG. 3, the buyer has a credit limit (buyer credit limit 312) of $125,000,000.00 and has a minimum buyer availability 320 of $15,000,000.000. The buyer credit limit 312 indicates a maximum dollar amount of invoices that the bank will accept from the buyer on credit. When the buyer credit limit 312 is reached, any additional invoices from the buyer will need to be sold for syndication. However, in this example the minimum buyer availability 320 effectively reduces the credit limit by $15,000,000.00 and creates an effective funding threshold of $110,000,000.00. Therefore, the funding need for today 322 is $660,825.79 ($110,660,825.79−$110,000,000.00). This means that at least $660,825.79 of invoices needs to be sold today.

The following discussion relates to funding for the next day (today+1) and refers to values in column 306. Column 306 shows that for the next day a dollar amount of forecasted non-syndicated invoices (forecasted total non-syndicated outstandings 330) is $110,010,825.79. This dollar amount is calculated by starting with the forecasted non-syndicated invoice total from today ($110,660,825.79) and adjusting this dollar amount as follows. Any projected new invoices expected to arrive on today+1 (projected new invoices 328), in this example $500,000.00, are added to the dollar amount. In addition, any payments that the bank needs to make to syndicated participants on today+1 (syndicated portion of scheduled payments due 326), in this example $250,000.00, are added to the dollar amount, because these payments constitute a funding need for the bank. In addition, any scheduled payments on invoices due from the buyer (scheduled payments due 324), in this example $400,000.00, are subtracted from the dollar amount. Thus, for this example, the forecasted total non-syndicated outstandings 330 for today+1 is equal to $111,010,825.79 ($110,660,825.79+$500,000.00+$250,000.00−$400,000.00). When $110,010,825.79 is subtracted from the effective funding threshold of $110,000,000.00, a funding need (funding needed 334) of $1,010,825.79 is forecasted for today+1. This means that at least $1,010,825.79 of invoices needs to be sold on today+1.

The example spreadsheet 300 also includes categories for buyer availability 316, utilization 318 and forecasted availability 332. As shown, for today there is a minimum buyer availability of $15,000,000.00 and a funding need 322 of $660,825.79. This produces a buyer availability of $14,339,174.21 ($15,000,000.00−$660,825.79) and a utilization 318 of 88.5% (14,339,174.21/15,000,000.00). When the buyer availability of $14,339,174.21 is adjusted by the scheduled payments due 324, syndicated portion of scheduled payments due 326 and projected new invoices 328 for today+1, a forecasted availability 332 of $13,989,174.21 is generated ($14,339,174.21+$500,000.00+$250,000.00−$400,000.00).

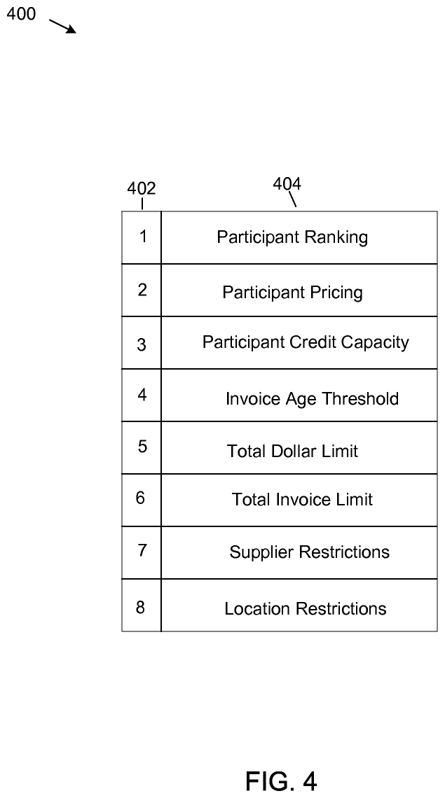

FIG. 4 shows an example table 400 that lists criteria for determining syndication participants for financing invoices. The example table 400 includes a column for a ranking order 402 for the criteria and a column 404 for the criteria. As shown in table 400, the criteria for determining syndication participants for financing invoices are examined in the order of 1) participant ranking, 2) participant pricing, 3) participant credit capacity, 4) invoice age threshold, 5) total dollar limit, 6) total invoice limit, 7) supplier restrictions and 8) location restrictions.

Participant ranking is the first criterion to be examined. Syndication participants are given a ranking from 1-5, with 1 being the highest ranking A syndication participant with the highest ranking is given first priority to be accepted as a syndication participant. The participant ranking comprises a subjective ranking of the participant by the bank.

Participant pricing is the next criterion to be examined. A syndication participant having a lowest discount is given the highest priority to be accepted as a syndication participant. The discount is a discount of the face value of an invoice that the syndication participant finances for the bank. The discount represents income to the syndication participant as a result of purchasing the invoice from the bank. The lower the discount, the less the syndication participant charges the bank.

Participant credit capacity is the next criterion to be examined. The participant credit capacity represents a maximum credit limit for the participant. A syndication participant with the largest credit capacity is given priority.

Invoice age threshold in the next criterion to be examined. The invoice age threshold represents the maximum number of days between a settlement date and a due date on an invoice that the syndication partner is willing to accept. A syndication partner with the highest invoice age threshold is given priority.

Total dollar limit of invoices is the next criterion to be examined. The total dollar limit represents the maximum dollar amount of invoices that the syndication participant is willing to purchase. A syndication partner with the highest total dollar limit is given priority.

Total number of invoices is the next criterion to be examined. The total number of invoices represents the total number of invoices that can be selected by the syndication partner. A syndication partner with the highest total number of invoices is given priority.

Supplier restrictions is the next criterion to be examined. The supplier restrictions comprise suppliers from which syndication participants will not accept invoices. The supplier restrictions can be based on a country in which a supplier is located. Some syndication participants may not accept invoices from certain countries. For example, some syndication participants only accept suppliers from the United States. The supplier restrictions can also be based on a past history with a supplier. For example, some syndication partners may refuse to deal with certain suppliers because of one or more previous bad experiences with a supplier. A syndication partner with the least amount of invoices that would be eliminated by supplier restrictions is given priority.

Location restrictions is the last criterion to be examined. The location restrictions comprise geographical locations from which syndication participants will not accept invoices. A syndication participant with the least amount of invoices that would be eliminated by location restrictions is given priority.

The auto-selection engine 202 evaluates the criteria shown in table 400 in the order shown to determine which syndication partners to select. When multiple participants have the same ranking for a particular criterion, the next ordered criterion is evaluated until one syndication participant is selected. When there is a tie after all criteria have been evaluated, alphabetical order of the syndication participants is used to break the tie.

Once a syndication participant is selected in any location, supplier and invoice age threshold restrictions are applied to pare down a list of available invoices for the syndication participant. Invoices are sold to the participant up to their limits. Invoices are sorted in descending order by amount so that the largest invoices are sold first. Once a limit for a participant is reached, if there are more invoices left to be sold, the auto-selection engine 202 determines the next best qualified syndication participant until the required dollar amount of invoices to sell is reached. Partial invoices are not sold. The dollar amount of invoices that are sold is equal to or greater than the forecasted dollar amount needed by the bank.

Once a set of invoices is selected for the required dollar amount, a settlement statement is generated for the invoices. The syndication participants pay the bank the dollar amount of invoices they have purchased from the bank. When the due date of an invoice occurs and payment for the invoice is received at the bank from the buyer, the bank sends a cash payment to the syndication participant for the dollar amount of the invoice.

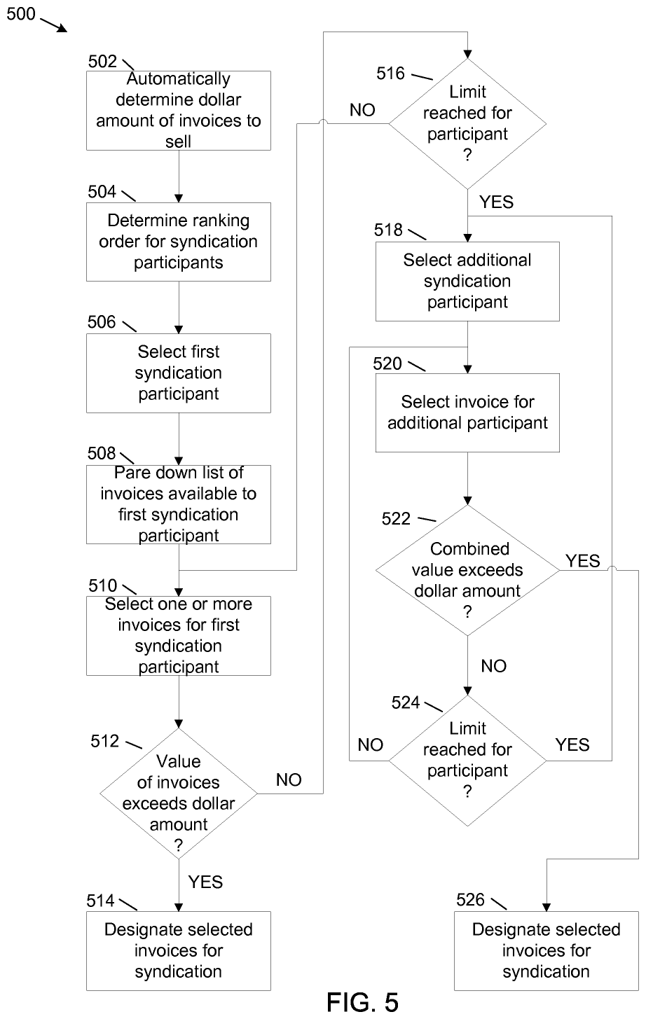

FIG. 5 shows a flowchart of an example method 500 for selecting invoices for syndication.

At operation 502 a dollar amount of invoices to sell is automatically forecast. In an example implementation, a specific dollar amount of the invoices to sell is forecasted on a daily basis. The specific dollar amount represents a daily forecasted amount needed to fund payment to syndicated participants who hold invoices from a specific buyer. In the example implementation the forecasted amount is determined by the auto-selection engine 202 determining a dollar amount of non-syndicated invoices held at the financial institution server computer 106 from a specific buyer. An effective credit limit is determined by subtracting a minimum buyer availability from a buyer credit limit. The dollar amount of invoices to sell is determined by subtracting the effective credit limit from the dollar amount of non-syndicated invoices.

At operation 504, a ranking order is determined for syndication participants. As discussed earlier herein, in an example implementation the ranking order is determined by evaluating the following factors in order: 1) overall participant ranking, 2) participant pricing, 3) participant credit capacity, 4) invoice age threshold, 5) total dollar limit of invoices than can be selected for the participant, 6) total number of invoices that can be selected for the participant, 7) supplier restrictions and 8) location restrictions. In other implementations more or fewer factors may be considered and the factors may be considered in a different order. At operation 506, a first syndication participant is selected based on the ranking order.

At operation 508, a list of available invoices for the first syndication participant is pared down to eliminate one or more invoices. In one example implementation, the list of invoices is reduced in size to eliminate invoices based on a days sales outstanding (DSO) value for the originator of the invoice (the buyer). As discussed earlier herein, the DSO refers to the number of days from the settlement date (in this case when the invoice is sold to the syndication participant) and the payment due date of the invoice. For this example implementation, all invoices having a DSO of 20 days or less are eliminated from the list of available invoices. In other implementations, other DSO values may be used and other factors may be considered in eliminating invoices from availability to syndication participants. Some other factors may include location restrictions, supplier restrictions and invoice age threshold restrictions.

At operation 510, one or more invoices are selected for the first syndication participant. Generally invoices are sorted for selection in order of amount, so that the largest invoices are selected first. The invoices are selected with a goal of exceeding the forecasted dollar amount by a minimal value. For example, if there are enough invoices available for selection that the dollar amount can be reached, because partial invoices cannot be sold, the value of the invoices selected will likely exceed the dollar amount. Some sets of selected invoices will exceed the dollar amount by more than other sets of selected invoices. The auto-engine 202 attempts to select a set of invoices that exceed the dollar amount but that go over the dollar amount by a minimum value compared to other sets of invoices that can be selected.

At operation 512, a determination is made as to whether the value of the selected invoices exceeds the dollar amount. When the value of the invoices exceeds the dollar amount, at operation 514, the selected invoices are designated for syndication with the first syndication participant. An assumption is that when the value of the invoices exceeds the dollar amount, the invoices selected at operation 510 are such that dollar amount is exceeded by a minimal value, as explained earlier herein.

When the value of the invoices does not exceed the required dollar amount and is not equal to the required dollar amount, at operation 516, a determination is made as to whether the invoices selected at operation 510 exceed a total dollar limit or a total number of invoices limit for the syndicated participant. When a determination is made that the limit is not reached for the participant, control returns to operation 510 and one or more additional invoices are selected for the syndication participant.

When a determination is made at operation 516 that the limit for the participant has been reached, at operation 518 and additional syndication participant is selected. In an example implementation, the additional syndication participant is a syndication participant having the next highest ranking in the ranking order of syndication participants from operation 504.

At operation 520 an invoice is selected for the additional syndication participant of operation 518. At operation 522, a determination is made as to whether a combined value of the invoices selected at operation 510 and the invoice selected at operation 522 exceeds the required forecasted dollar amount. Again, the assumption is that when the combined value exceeds the required forecasted dollar amount, invoices are selected so that the dollar value is exceeded by a minimal amount.

When a determination is made at operation 522 that the combined value exceeds the required forecasted dollar amount, at operation 526, the invoices selected at operations 510 and 520 are designated as being selected for syndication. The invoices selected at operation 510 are designated for syndication to the first syndication participant and the invoice(s) selected at operation 520 are designated for syndication to the additional syndication participant.

When a determination is made at operation 522 that the combined value does not exceed the required forecasted dollar amount, at operation 524, a determination is made as to whether an invoice limit has been reached for the additional syndication participant. When a determination is made at operation 524 that the invoice limit has been reached, control returns to operation 518 and another additional syndication partner is selected based on the ranking order. When a determination is made at operation 524 that the invoice limit has not been reached, control returns to operation 520 and another invoice is selected for the current syndication participant.

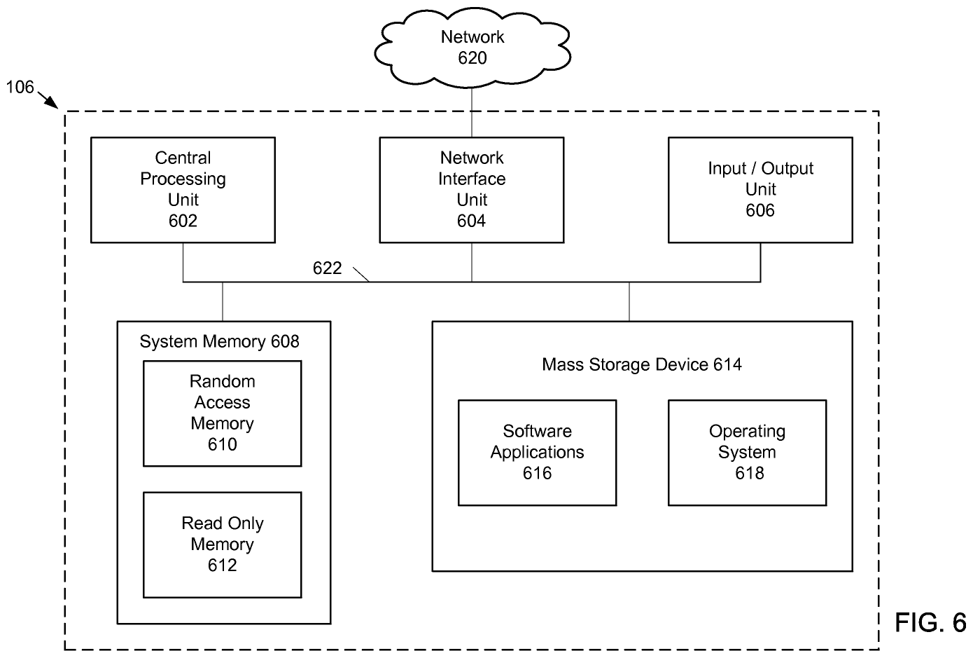

As illustrated in the example of FIG. 6, financial institution server computer 106 includes at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the financial institution server computer 106, such as during startup, is stored in the ROM 612. The financial institution server computer 106 further includes a mass storage device 614. The mass storage device 614 is able to store software instructions and data. A central processing unit, system memory and mass storage device similar to that in FIG. 6 are also included in financial institution server computer 106.

The mass storage device 614 is connected to the CPU 602 through a mass storage controller (not shown) connected to the system bus 622. The mass storage device 614 and its associated computer-readable data storage media provide non-volatile, non-transitory storage for the financial institution server computer 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computer 106.

According to various embodiments of the invention, the financial institution server computer 106 may operate in a networked environment using logical connections to remote network devices through the network 620, such as a wireless network, the Internet, or another type of network. The financial institution server computer 106 may connect to the network 620 through a network interface unit 604 connected to the system bus 622. It should be appreciated that the network interface unit 604 may also be utilized to connect to other types of networks and remote computing systems. The financial institution server computer 106 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the financial institution server computer 106 can store software instructions and data. The software instructions include an operating system 618 suitable for controlling the operation of the financial institution server computer 106. The mass storage device 614 and/or the RAM 610 also store software instructions, that when executed by the CPU 602, cause the financial institution server computer 106 to provide the functionality of the financial institution server computer 106 discussed in this document. For example, the mass storage device 614 and/or the RAM 610 can store software instructions that, when executed by the CPU 602, cause the financial institution server computer 106 to display received data on the display screen of the financial institution server computer 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. An electronic computing device comprising:
a processing unit; and
system memory, the system memory including instructions which, as executed by the processing unit, cause the electronic computing device to:
select invoice data associated with a plurality of invoices, each of the plurality of invoices being an itemized list of goods or services specifying price and terms of sale;
select one or more syndication participant identifiers based upon predetermined criteria, each of the one or more syndication participant identifiers being associated with a different financial institution with a capacity to finance a plurality of the invoices, wherein the predetermined criteria is:
selected from one or more of: pricing; credit capacity; invoice age; total dollars; total invoices; supplier restrictions; and location restrictions; and
received from each respective financial institution;
automatically determine a first dollar amount of invoices from the invoice data associated with the plurality of invoices to sell to the one or more syndication participant identifiers, wherein the first dollar amount is a daily forecasted amount needed to fund payment to the one or more syndicated participants;
determine a ranking order for the one or more syndication participant identifiers;
select a first syndication participant identifier from the one or more syndication participant identifiers with a high ranking order;
select one or more first invoice data from the invoice data associated with the plurality of invoices for the first syndication participant identifier;
determine that a first total for the one or more first invoice data is equal or greater than the first dollar amount, wherein the first total is a sum of invoice amounts from the one or more first invoice data; and
designate, for syndication to the first syndication participant identifier, the one or more first invoice data.

2. The electronic computing device of claim 1, further comprising instructions which, as executed by the processing unit, cause the electronic computing device to:
automatically determine a second dollar amount of invoices from the invoice data associated with the plurality of invoices to sell to one or more additional syndication participant identifiers, each of the one or more additional syndication participant identifiers being an identifier for a financial institution with a capacity to finance a plurality of the invoices, wherein the second dollar amount is a difference between the first dollar amount and the first total;
select a second syndication participant identifier from the one or more additional syndication participant identifiers;
select one or more second invoice data from the invoice data associated with the plurality of invoices for the second syndication participant identifier;
determine that a second total for the one or more second invoice data is less than the second dollar amount, wherein the second total is a sum of invoice amounts from the one or more second invoice data;
select a third syndication participant identifier from the one or more additional syndication participant identifiers;
select third invoice data from the invoice data associated with the plurality of invoices for the third syndication participant identifier until a sum of the second total and a third total is equal to or greater than the second dollar amount, wherein the third total comprises a dollar amount of the one or more third invoices; and
designate the selected third invoices for syndication to the selected third syndication participant identifier.

3. The electronic computing device of claim 2, further comprising instructions which, as executed by the processing unit, cause the electronic computing device to select the one or more additional syndication participant identifiers based on ranking order, a highest ranked of the one or more additional syndication participant identifiers being selected first.

4. The electronic computing device of claim 1, wherein automatically determine a first dollar amount of invoices from the invoice data associated with the plurality of invoices to sell to one or more syndication participant identifiers comprises:
determine a dollar amount of non-syndicated invoices for a buyer;
determine a credit limit for the buyer;
determine a minimum dollar amount of invoices that can be obtained from the buyer;
obtain a buyer limit by subtracting the minimum dollar amount of invoices from the credit limit;
subtract the buyer limit from the dollar amount of non-syndicated invoices; and
when a result of the subtraction is a positive number, designate the positive number as the first dollar amount.

5. The electronic computing device of claim 1, wherein select the one or more first invoice data from the invoice data associated with the plurality of invoices for the first syndication participant identifier further comprises select a combination of first invoices from invoices available for selection to optimize the selection of first invoices, the optimization of the selection comprising selecting first invoices such that a value of the first invoices exceeds the first dollar amount by a minimum value.

6. The electronic computing device of claim 1, wherein select the one or more first invoice data from the invoice data associated with the plurality of invoices for the first syndication participant identifier further comprises only selecting invoices which have a days sales outstanding (DSO) value of greater than a predetermined amount, wherein the DSO value is a number of days from a settlement date for an invoice and a date on which the invoice is due.

7. The electronic computing device of claim 1, wherein select a first syndication participant identifier with a high ranking order comprises selecting a participant charging a lowest discount for syndicating an invoice.

8. The electronic computing device of claim 7, wherein select a first syndication participant identifier with a high ranking order further comprises selecting a syndication participant identifier with a highest capacity to purchase invoices.

9. The electronic computing device of claim 8, wherein select a first syndication participant identifier with a high ranking order further comprises selecting a syndication participant identifier that accepts invoices having due dates that are a highest number of days from a day on which the invoices are selected.

10. The electronic computing device of claim 1, further comprising:
permitting two or more of the syndication participant identifiers to view information regarding invoices available for syndication;
receiving bids from the two or more syndication participant identifiers for purchasing one or more of the invoices available for syndication; and
selecting a syndication participant identifier having a low bid for an invoice.

11. The electronic computing device of claim 1, further comprising:
on a daily basis, check an invoice hold capacity for one or more syndication participant identifiers;
determine whether the invoice hold capacity for each of the one or more syndication participant identifiers is greater than a predetermined percentage of a maximum invoice hold capacity; and
when the invoice hold capacity for a syndication participant identifier is greater than the predetermined percentage, send an alert to the syndication participant identifier.

12-20. (canceled)
